(19) United States
(12) Patent Application Publication
(10) Pub. No.: US 2026/0241851 A1
(43) Pub. Date: Aug. 20, 2026

(54) CONTROL APPARATUS FOR A VEHICLE LAMP, VEHICLE LAMP SYSTEM

(71) Applicant: Stanley Electric Co., Ltd., Tokyo (JP)

(72) Inventors: Yuki ISHII, Tokyo (JP); Katsutoshi FUKAZAWA, Tokyo (JP); Takeshi WARAGAYA, Tokyo (JP); Wataru NAKASHIMA, Tokyo (JP); Ayumu YAMAGUCHI, Tokyo (JP)

(21) Appl. No.: 19/165,402

(22) PCT Filed: Feb. 15, 2024
(86) PCT No.: PCT/JP2024/005194

§ 371 Date: Sep. 15, 2025

(30) Foreign Application Priority Data
Mar. 13, 2023 (JP) 2023-038644

(51) Int. Cl. B60Q 1/08; B60Q 1/14; B60Q 1/16; B60Q 1/18

(52) U.S. Cl. CPC B60Q 1/085; B60Q 1/143; B60Q 1/16; B60Q 1/18; B60Q 2300/054; B60Q 2300/056; B60Q 2300/112; B60Q 2300/312; B60Q 2300/41

(57) ABSTRACT

An apparatus for controlling a vehicle lamp having a variable light distribution pattern including: a first sensor detecting an amount of rainfall; a second sensor detecting size of raindrops; and a controller connected to the sensors; where the controller controls the vehicle lamp to emit a first beam when a relationship between the amount of rainfall detected by the first sensor and the size of raindrops detected by the second sensor corresponds to a first weather condition estimated not to cause occurrence of a light veiling phenomenon, and where the controller controls the vehicle lamp to emit a second beam having an illuminance set relatively lower than that of the first beam when the relationship between the amount of rainfall detected by the first sensor and the size of raindrops detected by the second sensor corresponds to a second weather condition estimated to cause occurrence of the light veiling phenomenon.

This application is a U.S. National Stage Application under 35 U.S. C § 371 of International Patent Application No. PCT/JP2024/005194 filed Feb. 15, 2024, which claims the benefit of priority under 35 U.S.C. § 119 to Japanese Patent Application No. 2023-038644 filed Mar. 13, 2023, the disclosures of all of which are hereby incorporated by reference in their entireties.

### TECHNICAL FIELD

The present disclosure relates to a control apparatus for a vehicle lamp and a vehicle lamp system.

### BACKGROUND ART

Japanese Patent Laid-Open Publication No. 2022-109440 (Patent Document 1) describes a vehicle lamp system that controls the light emitted by a first headlight unit to be relatively darker than the light emitted by a second headlight unit when the amount of rainfall is equal to or greater than a predetermined value. According to this prior art, a light veiling phenomenon, in which strong light hits raindrops in the air and causes light to scatter and become hazy, is suppressed. However, depending on the weather condition, the light veiling phenomenon may occur even when the amount of rainfall is small, which may lead to a decrease in visibility of pedestrians on the roadside, for example.

### PRIOR ART DOCUMENT

### Patent Document

[Patent Document 1] Japanese Patent Laid-Open Publication No. 2022-109440

### SUMMARY OF THE INVENTION

### Technical Problem

In a specific aspect, it is an object of the present disclosure to provide a technology that can further improve pedestrian visibility.

### Solution to the Problem

(1) An apparatus according to one aspect of the present disclosure is a control apparatus for a vehicle lamp for controlling the operation of the vehicle lamp having a variable light distribution pattern including: (a) a first sensor capable of detecting an amount of rainfall; (b) a second sensor capable of detecting size of raindrops; and (c) a controller connected to each of the first sensor and the second sensor; (d) where the controller (d1) controls the vehicle lamp to emit a first beam when a relationship between the amount of rainfall detected by the first sensor and the size of raindrops detected by the second sensor corresponds to a first weather condition that is estimated not to cause occurrence of a light veiling phenomenon; and where the controller (d2) controls the vehicle lamp to emit a second beam having an illuminance set relatively lower than that of the first beam when the relationship between the amount of rainfall detected by the first sensor and the size of raindrops detected by the second sensor corresponds to a second weather condition that is estimated to cause occurrence of the light veiling phenomenon.
(2) A vehicle lamp system according to one aspect of the present disclosure is a vehicle lamp system including: the control apparatus according to the above-described (1); and a vehicle lamp connected to the control apparatus.

According to the above configurations, it is possible to further improve visibility of pedestrians.

### BRIEF DESCRIPTION OF THE DRAWINGS

FIG. 1 is a diagram showing the configuration of a vehicle lamp system according to one embodiment.

FIG. 2 is a diagram for explaining the conditions under which a light veiling phenomenon occurs.

FIG. 3 is a diagram for explaining an illumination mode that is variably set according to weather and vehicle speed.

FIG. 4 is a diagram for explaining an illumination mode that is variably set according to weather and vehicle speed.

FIG. 5(A) and FIG. 5(B) are diagrams for illustratively explaining the first mode.

FIG. 5(C) and FIG. 5(D) are diagrams for illustratively explaining the second mode.

FIG. 6(A) and FIG. 6(B) are diagrams for illustratively explaining the third mode.

FIG. 6(C) and FIG. 6(D) are diagrams for illustratively explaining the fourth mode and the fourth′ mode.

FIG. 7(A) and FIG. 7(B) are diagrams for illustratively explaining the fifth mode.

FIG. 7(C) and FIG. 7(D) are diagrams for illustratively explaining the sixth mode.

FIG. 8(A) and FIG. 8(B) are diagrams for illustratively explaining the seventh mode.

FIG. 8(C) and FIG. 8(D) are diagrams for illustratively explaining the eighth mode.

FIG. 9 is a flowchart showing the operating procedure of a vehicle lamp system when it is possible to form an adaptive driving beam (ADB).

FIG. 10 is a flowchart showing the operating procedure of a vehicle lamp system when it is not possible to form an adaptive driving beam (ADB).

### MODE FOR CARRYING OUT THE INVENTION

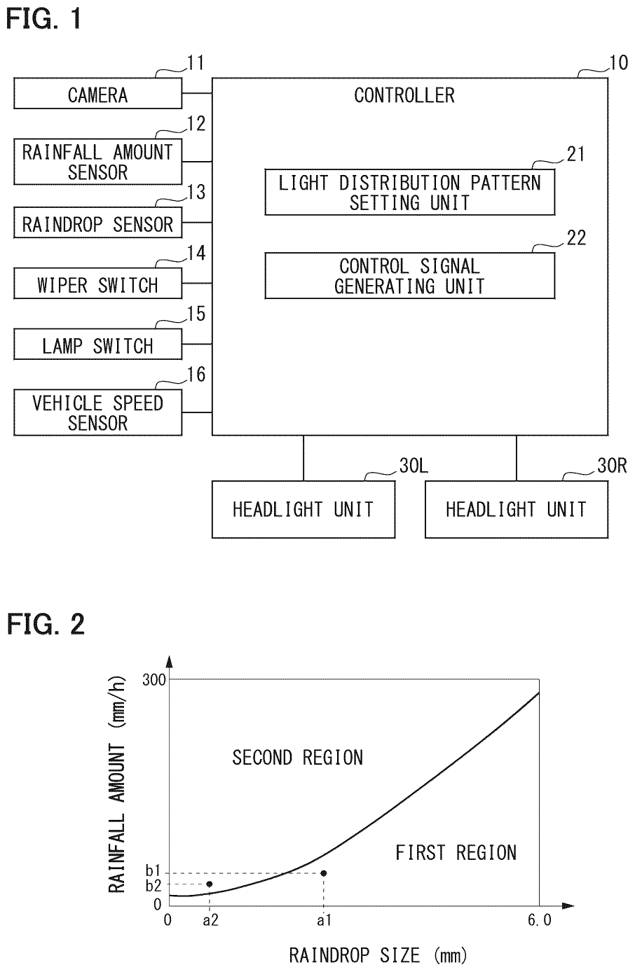

FIG. 1 is a diagram showing the configuration of a vehicle lamp system according to one embodiment. The vehicle lamp system shown in the figure is configured to include a controller 10, a camera 11, a rainfall amount sensor 12, a raindrop sensor 13, and a pair of headlight units 30L, 30R. This vehicle lamp system is for emitting light forward of the vehicle. Here, in the present specification, a control apparatus for a vehicle lamp is configured to include controller 10, camera 11, rainfall amount sensor 12, and raindrop sensor 13.

Controller 10 controls the light irradiation operation of each headlight unit 30L, 30R. This controller 10 can be configured using a computer system equipped with, for example, a processor (CPU: Central Processing Unit), a ROM (Read Only Memory), a RAM (Random Access Memory), a storage device such as a flash memory, an input/output interface, etc. Controller 10 of the present embodiment is capable of performing a specified function by having the processor read and execute a program previously stored in the storage device (or ROM).

Further, controller 10 is also connected to each of a wiper switch 14, a lamp switch 15, and a vehicle speed sensor 16 provided in the vehicle. Here, the word “connected” includes direct connection via a signal line or the like, and indirect connection via a control unit or the like (which is not shown). Further, “connection” via the control unit or the like also includes receiving respective operating statuses of wiper switch 14, lamp switch 15, and vehicle speed sensor 16 as digital signals or the like from the control unit or the like via communication means.

Camera 11 detects the situation, such as the position of forward vehicles (preceding vehicles, oncoming vehicles) and pedestrians, by performing a predetermined image recognition process based on image data obtained by photographing the space forward of the own vehicle. Here, note that some or all of the image recognition process function may be provided by controller 10 side. In such a case, image data is supplied from camera 11 to controller 10, and the image recognition process is performed by executing a predetermined program in controller 10.

Rainfall amount sensor 12 detects the amount of rainfall where the own vehicle is located and outputs a signal (or data, the same applies hereinafter) that indicates changes according to the amount of rainfall. Various publicly known rainfall amount sensors can be used as rainfall amount sensor 12, for example, a rainfall amount sensor consisting of a pair of a light-emitting element that emits band-shaped laser beam and a light-receiving element that receives the laser beam can be used. This rainfall amount sensor can detect the particle size and speed of raindrops based on the degree of decrease in the voltage signal generated by the light-receiving element when raindrops pass through the band-shaped laser beam. Then, the amount of rainfall can be determined based on the particle size and speed of the raindrops.

Raindrop sensor 13 detects the size (diameter) of raindrops where the own vehicle is located and outputs a signal (or data) indicating changes according to its size. Various publicly known raindrop sensors can be used as raindrop sensor 13, for example, a raindrop sensor that has a pair of electrodes and is configured so that when raindrops adhere to the electrodes in a manner that connects the electrodes, a current flows between them. In this rainfall sensor, for example, multiple transparent electrodes are arranged on a part of the windshield, with the distance between the electrodes being 0.1 mm for example, and the current flowing between the electrodes changes depending on the size of the raindrops that adhere to the electrodes, so that the size of the raindrops can be detected from the magnitude of the current.

Wiper switch 14 is installed near the driver's seat of the own vehicle in a position that can be operated by the driver. This wiper switch 14 is operated by the driver when the driver wishes to operate the wipers installed on the front windshield and/or the rear glass of the own vehicle.

Lamp switch 15 is installed near the driver's seat of the own vehicle in a position where it can be operated by the driver. This lamp switch 15 is operated by the driver when the driver wishes to emit light from the headlight units 30L and 30R. Further, lamp switch 15 serves as a turn signal switch for turning on the direction indicator lights.

Vehicle speed sensor 16 detects the speed of the own vehicle. Vehicle speed sensor 16 outputs a pulse signal in response to the rotation of the wheels, for example. The vehicle speed can be determined based on the output pulse signal.

Controller 10 includes a light distribution pattern setting unit 21 and a control signal generating unit 22 as functional blocks realized by program execution.

Light distribution pattern setting unit 21 sets the light distribution pattern of the light emitted by each headlight unit 30L, 30R based on the detection results of forward vehicles, etc. by camera 11, the amount of rainfall detected by rainfall amount sensor 12, and the size of raindrops detected by raindrop sensor 13.

Control signal generating unit 22 generates a control signal for causing each headlight unit 30L, 30R to form illumination light according to the light distribution pattern set by light distribution pattern setting unit 21, and supplies the control signal to each headlight unit 30L, 30R.

A pair of headlight units 30L, 30R are mounted at predetermined positions on the left and right sides of the front of the own vehicle, and operate in response to control signals provided by controller 10 to form light to be irradiated in front of the own vehicle. The headlight units 30L, 30R of the present embodiment can variably set the light distribution pattern, and can form a low beam (passing light) and a high beam (driving light), as well as an adaptive driving beam (ADB), which is an illumination light that is partially dimmed (or turned off) in a range that is set according to the position of the forward vehicles. Further, in addition to the low beam, the high beam, and the adaptive driving beam, headlight units 30L, 30R can also form an additional beam, which is an additional illumination light for irradiating roadside areas, etc., depending on rainfall conditions.

Various publicly known configurations can be adopted for each of headlight units 30L, 30R. For example, a high beam, a low beam, and an additional beam can be formed by a lamp unit configured by combining a light source bulb with a reflector and a shielding plate. Further, an adaptive driving beam can be formed by using a lamp unit in which light emitting elements such as LEDs (Light Emitting Diodes) are arranged in one or two directions and the lighting state of each light emitting element can be controlled individually. Further, the adaptive driving beam can be formed by using a lamp unit that includes a light source and a liquid crystal element, and capable of individually controlling the light transmission state of each pixel of the liquid crystal element. Further, the adaptive driving beam can be formed by using a lamp unit that includes a light emitting element such as a laser diode and a scanning element such as a mirror device that scans the light emitted from the light emitting element, and capable of controlling the timing of turning on and off the light emitting element and the scanning timing by the scanning element. Furthermore, in the lamp unit of these configurations, in addition to the adaptive driving beam, a high beam, a low beam, and an additional beam may be formed.

FIG. 2 is a diagram for explaining the conditions under which a light veiling phenomenon occurs. In FIG. 2, rainfall amount and raindrop size are each set as variables, the vertical axis is set to rainfall amount, and the horizontal axis is set to raindrop size, and the boundary condition under which the light veiling phenomenon occurs is shown by a characteristic line (boundary). In the illustrated example, the applicant actually used an experimental facility to confirm the rainfall conditions and the presence or absence of light veiling under several conditions in a range of raindrop size 0 to 6.0 (mm) and rainfall amount 0 to 300 (mm/h) through subjective evaluation, and obtained a characteristic line by curve approximation based on the results. As shown in the figure, two regions separated by the characteristic line are obtained within the range of raindrop size 0 to 6.0 (mm) and rainfall amount 0 to 300 (mm/h). In the figure, the region below the characteristic line is a first region corresponding to a condition in which the light veiling phenomenon does not occur (first weather condition), and the region above the characteristic line is a second region corresponding to a condition in which the light veiling phenomenon does occur (second weather condition).

As illustrated in the figure, for example, when the raindrop size is relatively large (e.g., a1), the light veiling phenomenon may not occur when the amount of rainfall is relatively large (e.g., b1). On the other hand, when the raindrop size is relatively small (e.g., a2), the light veiling phenomenon may occur when the amount of rainfall is relatively small (e.g., b2). That is, simply using either the amount of rainfall or the raindrop size as a condition makes it difficult to accurately distinguish between a case where the light veiling phenomenon occurs and a case where the light veiling phenomenon does not occur. In the present embodiment, however, by focusing on the relationship between the amount of rainfall and the raindrop size and determining whether the relationship belongs to the first region or second region, the presence or absence of the light veiling phenomenon can be determined more accurately.

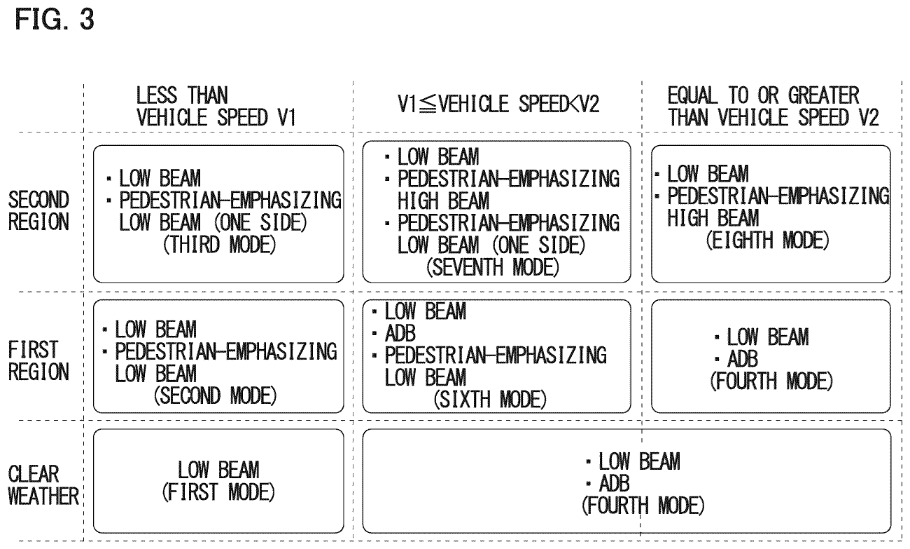

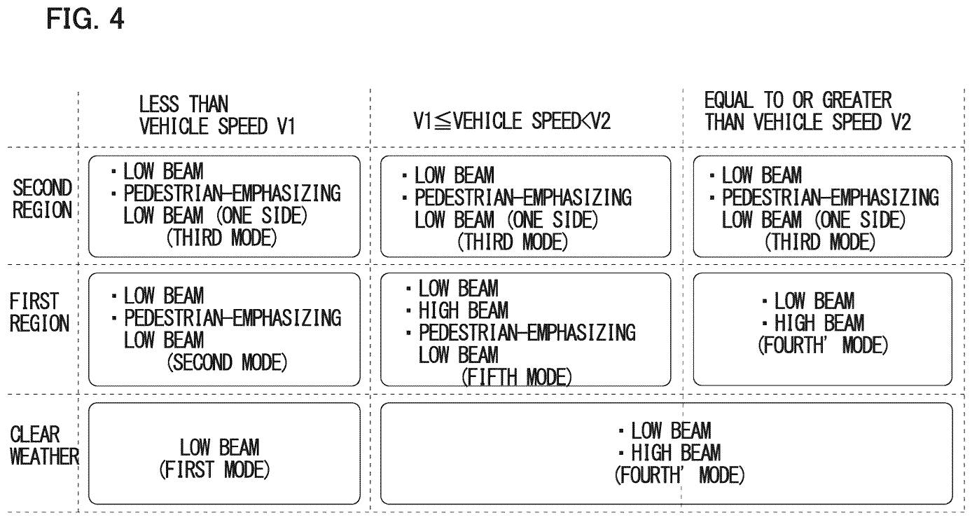

FIG. 3 and FIG. 4 are diagrams each illustrating illumination modes that can be variably set according to weather and vehicle speed. FIG. 3 shows a case in which an adaptive driving beam (ADB) can be formed, which is an illumination light that is partially dimmed (or turned off) within the high beam illumination range and is set according to the position of forward vehicles, etc. FIG. 4 shows a case in which an adaptive driving beam (ADB) cannot be formed within the high beam illumination range, but a normal high beam can be formed.

In each figure, the weather condition is classified into three types: clear weather (including non-rainy weather), the first region which is a weather condition in which the light veiling phenomenon does not occur, and the second region which is a weather condition in which the light veiling phenomenon does occur. Further, the vehicle speed is classified into three types: when the vehicle speed is less than a predetermined threshold value V1 (e.g., 30 km/h), when the vehicle speed is equal to or greater than threshold value V1 and less than threshold value V2 (e.g., 60 km/h), and when the vehicle speed is equal to or greater than threshold value V2. Therefore, when a matrix is created corresponding to each category of weather and vehicle speed, it can be divided into nine conditions. Then, one of the conditions is selected by light distribution pattern setting unit 21 depending on the weather and the vehicle speed.

First, referring to FIG. 3, the illumination mode in which each headlight unit 30L, 30R can form an adaptive driving beam (ADB) will be described.

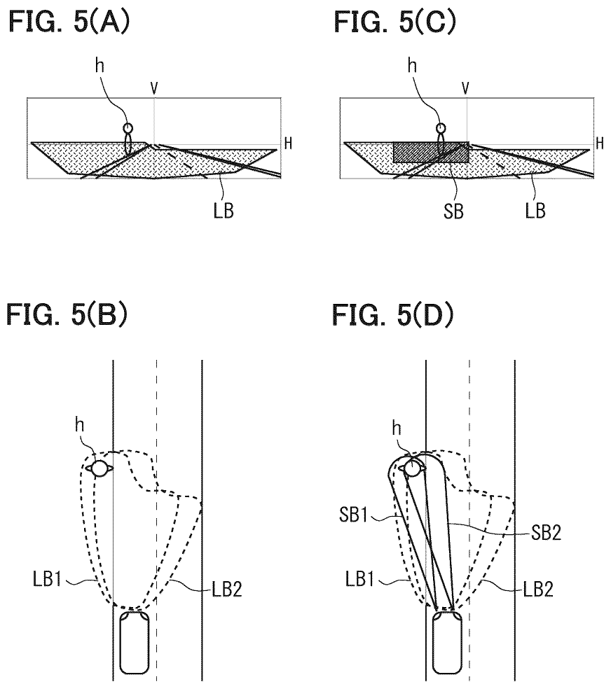

When the weather is clear and the vehicle speed is less than V1, the first mode, in which a low beam is emitted, is selected. A specific example of the first mode will be described later in FIG. 5(A) and FIG. 5(B). Here, the low beam refers to a light emitted so that potential traffic hazard objects such as other vehicles and pedestrians within a distance of approximately 40 m ahead of the own vehicle can be identified mainly at night.

When the weather is in the first region (no light veiling phenomenon) and the vehicle speed is less than V1, “second mode” is selected, which is a mode in which a pedestrian-emphasizing low beam is irradiated in addition to the low beam. A specific example of the second mode will be described later in FIG. 5(C) and FIG. 5(D). Here, the pedestrian-emphasizing low beam (First beam) refers to a light that is irradiated mainly toward an area that includes the sides of the own vehicle's lane within the low beam irradiation range, or as a more specific mode, toward an area that includes the road shoulder of the own vehicle's lane side (the shoulder adjacent to the lane in which the own vehicle is traveling). This pedestrian-emphasizing low beam improves the visibility of pedestrians on the road shoulder (including roadside strips and sidewalks) even in rainy weather when visibility is likely to be reduced, making it easier for the driver to spot pedestrians. Here, the mode of illuminating light toward “an area that includes the road shoulder of the own vehicle's lane side” is a concept that encompasses any of the following modes: illuminating the area so as to include the road shoulder, illuminating toward the road shoulder, illuminating the road shoulder, and illuminating the road shoulder as well as an area other than the road shoulder. This concept is also common to the pedestrian-emphasizing low beam and pedestrian-emphasizing high beam in each mode, such as the third mode described below.

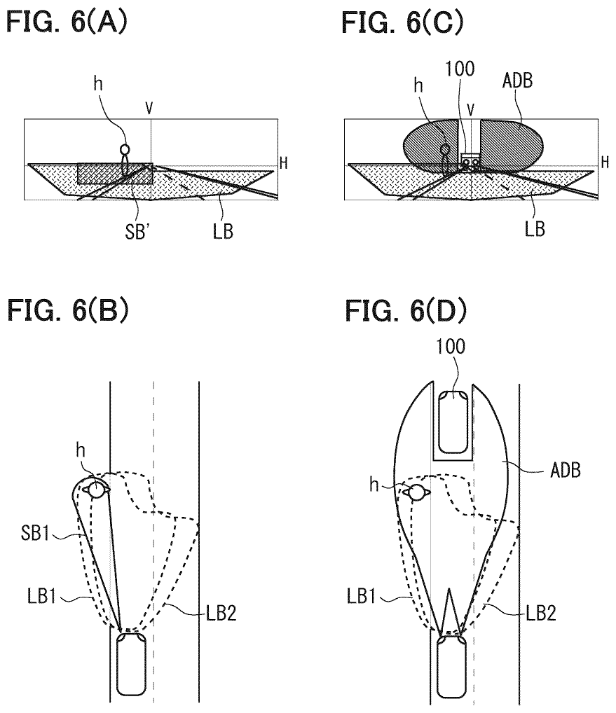

When the weather is in the second region (light veiling phenomenon present) and the vehicle speed is less than V1, a “third mode” is selected, which is a mode in which a pedestrian-emphasizing low beam is irradiated in addition to the low beam and the irradiated light intensity of the pedestrian-emphasizing low beam is relatively low. A specific example of the third mode are described later in FIG. 6(A) and FIG. 6(B). The pedestrian-emphasizing low beam (Second beam) with a narrower illumination range referred to here is a pedestrian-emphasizing low beam formed by dimming or turning off the light from headlight unit 30R on the driver's seat side of the own vehicle mainly within the illumination range of the low beam, and by using the light from headlight unit 30L on the side closer to the area including the side of the own vehicle's lane, or as a more specific mode, is a pedestrian-emphasizing low beam formed by irradiating light from headlight unit 30L that is closer to the area including the road shoulder of the own vehicle's lane side. Hereinafter, this pedestrian-emphasizing low beam will be referred to as “pedestrian-emphasizing low beam (one side)”. As a result, since the amount of light illuminating the front direction of the own vehicle becomes relatively small, the occurrence of light veiling phenomenon mainly viewed from the driver's seat in rainy weather is suppressed, visibility is ensured, and pedestrians on the road shoulder can be easily spotted.

When the weather is clear and the vehicle speed is equal to or greater than V1 but less than V2, a “fourth mode” is selected, which is a mode in which an adaptive driving beam (ADB) is irradiated. A specific example of the fourth mode will be described later in FIG. 6(C) and FIG. 6(D). The adaptive driving beam (ADB) referred to here is a light that is irradiated by partially dimming (or turning off) a range set according to the position, etc. of the forward vehicle, within the irradiation range of a high beam emitted, such that potential traffic hazard objects such as other vehicles and pedestrians within a distance of approximately 100 m ahead of the own vehicle can be identified mainly at night. Thus, this makes it possible to improve forward visibility while preventing glare to forward vehicles, etc.

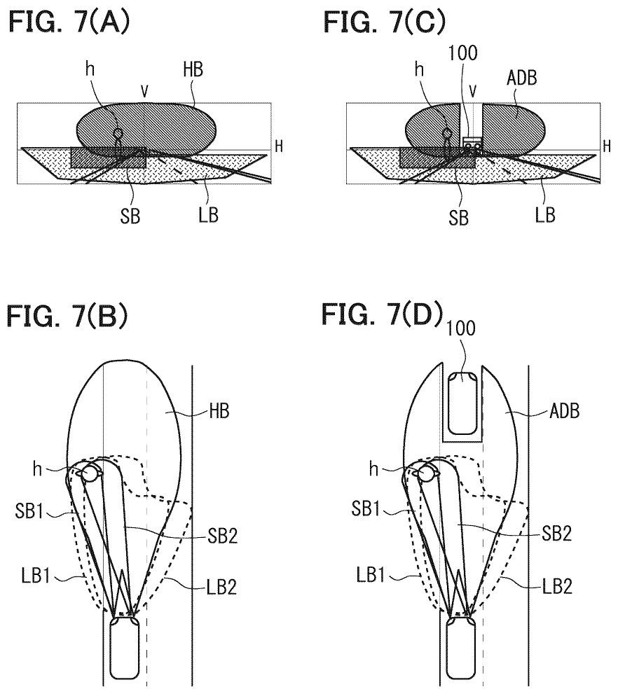

When the weather is in the first region (no light veiling phenomenon) and the vehicle speed is equal to or greater than V1 and less than V2, a “sixth mode” is selected, in which a pedestrian-emphasizing low beam is emitted in addition to the low beam and adaptive driving beam (ADB). A specific example of the sixth mode will be described later in FIG. 7(C) and FIG. 7(D). Here, the content and effects of the adaptive driving beam (ADB) and the pedestrian-emphasizing low beam are the same as those described above.

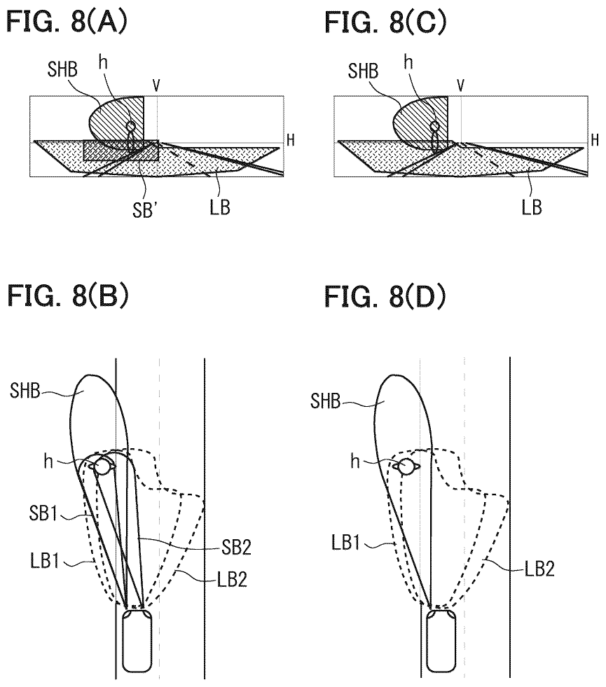

When the weather is in the second region (light veiling phenomenon present) and the vehicle speed is equal to or greater than V1 and less than V2, a “seventh mode” is selected, which is a mode in which a low beam, a pedestrian-emphasizing high beam, and a pedestrian-emphasizing low beam (one side) are irradiated. The pedestrian-emphasizing high beam (Third beam) is a light that is irradiated toward an area that includes the side of the own vehicle's lane within the high beam irradiation range, or as a more specific mode, is a light that is irradiated toward an area that includes the road shoulder on the side of the own vehicle's lane. A specific example of the seventh mode will be described later in FIG. 8(A) and FIG. 8(B).

When the weather is clear and the vehicle speed is equal to or greater than V2, a “fourth mode” is selected, which is a mode in which a low beam and an adaptive driving beam (ADB) are irradiated. Similarly, when the weather is in the first region (no light veiling phenomenon) and the vehicle speed is equal to or greater than V2, the “fourth mode” is selected, which is a mode in which a low beam and an adaptive driving beam (ADB) are irradiated.

When the weather is in the second region (light veiling phenomenon present) and the vehicle speed is equal to or greater than V2, an “eighth mode” is selected, which is a mode in which a pedestrian-emphasizing high beam is irradiated in addition to a low beam. A specific example of the eighth mode are described below in FIG. 8(C) and FIG. 8(D).

Next, with reference to FIG. 4, illumination modes when each headlight unit 30L, 30R is not capable of forming an adaptive driving beam (ADB) will be described. Here, note that description of the same illumination mode as that described above with reference to FIG. 3 will be omitted as appropriate.

When the weather is clear and the vehicle speed is less than V1, the first mode is selected, which is a mode in which a low beam is irradiated. When the weather is in the first region (no light veiling phenomenon) and the vehicle speed is less than V1, the second mode is selected, which is a mode in which a pedestrian-emphasizing low beam is irradiated in addition to a low beam. When the weather is in the second region (light veiling phenomenon present) and the vehicle speed is less than V1, the third mode is selected, which is a mode in which a pedestrian-emphasizing low beam (one side) is irradiated in addition to a low beam.

When the weather is clear and the vehicle speed is equal to or greater than V1 and less than V2, a “fourth′ mode” is selected, which is a mode in which a low beam and a high beam are irradiated. A specific example of the fourth′ mode will be described later in FIG. 6(C) and FIG. 6(D). When the weather is in the first region (no light veiling phenomenon) and the vehicle speed is equal to or greater than V1 and less than V2, a “fifth mode” is selected, which is a mode in which a pedestrian-emphasizing low beam is irradiated in addition to a low beam and a high beam. A specific example of the fifth mode will be described later in FIG. 7(C) and FIG. 7(D). When the weather is in the second region (light veiling phenomenon present) and the vehicle speed is equal to or greater than V1 and less than V2, the third mode is selected, which is a mode in which a low beam and a pedestrian-emphasizing low beam (one side) are irradiated.

When the weather is clear and the vehicle speed is equal to or greater than V2, the fourth′ mode is selected, which is a mode in which a low beam and a high beam are irradiated. Similarly, when the weather is in the first region (no light veiling phenomenon) and the vehicle speed is equal to or greater than V2, the fourth′ mode is selected, which is a mode in which a low beam and a high beam are irradiated. When the weather is in the second region (light veiling phenomenon present) and the vehicle speed is equal to or greater than V2, the third mode is selected, which is a mode in which a pedestrian-emphasizing low beam (one side) is irradiated in addition to a low beam.

FIG. 5(A) and FIG. 5(B) are diagrams for illustratively explaining the first mode. FIG. 5(A) illustrates the shape of the light irradiated onto a virtual screen placed at a specific position in front of the own vehicle (e.g., 25 m ahead). FIG. 5(B) illustrates in a plane view the shape of the light irradiated from each headlight unit 30L, 30R as viewed from above the own vehicle. Here, note that each figure conceptually illustrates the illumination mode, and for ease of illustration, the scales are not necessarily the same (the same applies hereinafter).

In the first mode, low beam LB is emitted in an area roughly below the horizontal line H, spreading left and right across the vertical line V (refer to FIG. 5(A)). Low beam LB is not emitted near the head of pedestrian h, but is emitted to its torso, feet, and other body parts. This low beam LB is obtained by combining low beams LB1, LB2 emitted from headlight units 30L, 30R installed on the left and right sides of the front of the own vehicle (refer to FIG. 5(B)).

FIG. 5(C) and FIG. 5(D) are diagrams for illustratively explaining the second mode. As described above, FIG. 5(C) shows the shape of the light on a virtual screen, and FIG. 5(D) shows the shape of the light as viewed from above the own vehicle. In the second mode, in addition to low beam LB as described above, pedestrian-emphasizing low beam SB is emitted as a light that mainly illuminates the road shoulder on the own vehicle's lane side within the low beam illumination range (refer to FIG. 5(C)). In the illustrated example, pedestrian-emphasizing low beam SB is emitted superimposed on low beam LB, at a position biased to the left side of the figure with reference to vertical line V (the road shoulder on the own vehicle's lane side). As a result, this emphasizes the presence of pedestrian h, making it easier to spot the pedestrian. This pedestrian-emphasizing low beam SB is obtained by combining pedestrian-emphasizing low beams SB1, SB2 emitted from each headlight unit 30L, 30R (refer to FIG. 5(D)).

FIG. 6(A) and FIG. 6(B) are diagrams for illustratively explaining the third mode. As described above, FIG. 6(A) shows the shape of the light on a virtual screen, and FIG. 6(B) shows the shape of the light as viewed from above the own vehicle. In the third mode, in addition to low beam LB as described above, pedestrian-emphasizing low beam SB′ which is a pedestrian-emphasizing low beam with a relatively low intensity is emitted as a light that mainly illuminates the road shoulder on the own vehicle's lane side within the low beam's illumination range (refer to FIG. 6(A)). In the illustrated example, pedestrian-emphasizing low beam SB′ is emitted superimposed on low beam LB at a position biased to the left side of the figure with reference to vertical line V (the road shoulder on the own vehicle's lane side). This pedestrian-emphasizing low beam SB′ is obtained by turning on headlight unit 30L and turning off (or dimming) headlight unit 30R of the left and right headlight units 30L and 30R (refer to FIG. 6B). As a result, this relatively reduces the amount of light illuminating the front of the own vehicle, thereby reducing the occurrence of light veiling phenomenon in the front as viewed mainly from the driver's seat in rainy weather, ensuring visibility, and making it easier to spot pedestrians h on the roadside.

FIG. 6(C) and FIG. 6(D) are diagrams for illustratively explaining the fourth mode and the fourth′ mode. As described above, FIG. 6(C) shows the shape of light on a virtual screen, and FIG. 6(D) shows the shape of light as viewed from above the own vehicle. In the fourth mode, in addition to low beam LB as described above, adaptive driving beam ADB is irradiated in an irradiation range that spreads left and right in the figure on either side of vertical line V in an area slightly below and above horizontal line H (refer to FIG. 6(C)). In the illustrated example, adaptive driving beam ADB is irradiated with a dimming range (or a light shielding range) according to the position of forward vehicle 100. This case corresponds to the fourth mode. In the case of a high beam, no such dimming range is provided (refer to FIG. 7(A) described below). Such case corresponds to the fourth′ mode.

FIG. 7(A) and FIG. 7(B) are diagrams for illustratively explaining the fifth mode. As described above, FIG. 7(A) shows the shape of the light on a virtual screen, and FIG. 7(B) shows the shape of the light as viewed from above the own vehicle. In the fifth mode, the same low beam LB and high beam HB as described above are emitted, and in addition, pedestrian-emphasizing low beam SB is emitted. As a result, this makes it easier to spot pedestrians.

FIG. 7(C) and FIG. 7(D) are diagrams for illustratively explaining the sixth mode. As described above, FIG. 7(C) shows the shape of the light on a virtual screen, and FIG. 7(D) shows the shape of the light as viewed from above the own vehicle. In the sixth mode, the same low beam LB and adaptive driving beam ADB as described above are emitted, and in addition, pedestrian-emphasizing low beam SB is emitted. As a result, this makes it easier to spot pedestrians.

FIG. 8(A) and FIG. 8(B) are diagrams for illustratively explaining the seventh mode. As described above, FIG. 8(A) shows the shape of the light on a virtual screen, and FIG. 8(B) shows the shape of the light as viewed from above the own vehicle. In the seventh mode, the same low beam LB and pedestrian-emphasizing low beam SB′ as described above are emitted, and further, pedestrian-emphasizing high beam SHB is emitted to selectively illuminate the road shoulder on the own vehicle's lane side. As shown in FIG. 8(B), the pedestrian-emphasizing high beam SHB is mainly formed by headlight units 30L on the left side of the own vehicle, but headlight unit 30R may also be slightly turned on to use the emitted light in combination. As a result, this makes it easier to spot pedestrians.

FIG. 8(C) and FIG. 8(D) are diagrams for illustratively explaining the eighth mode. As described above, FIG. 8(C) shows the shape of the light on a virtual screen, and FIG. 8(D) shows the shape of the light as viewed from above the own vehicle. In the eighth mode, the same low beam LB as described above is irradiated, and further, pedestrian-emphasizing high beam SHB is irradiated so as to selectively illuminate the road shoulder on the own vehicle's lane side. Unlike the seventh mode, pedestrian-emphasizing low beam SB (or SB′) is not irradiated. Thereby, it becomes easier to spot pedestrians while ensuring forward visibility even in a situation where a light veiling phenomenon may occur.

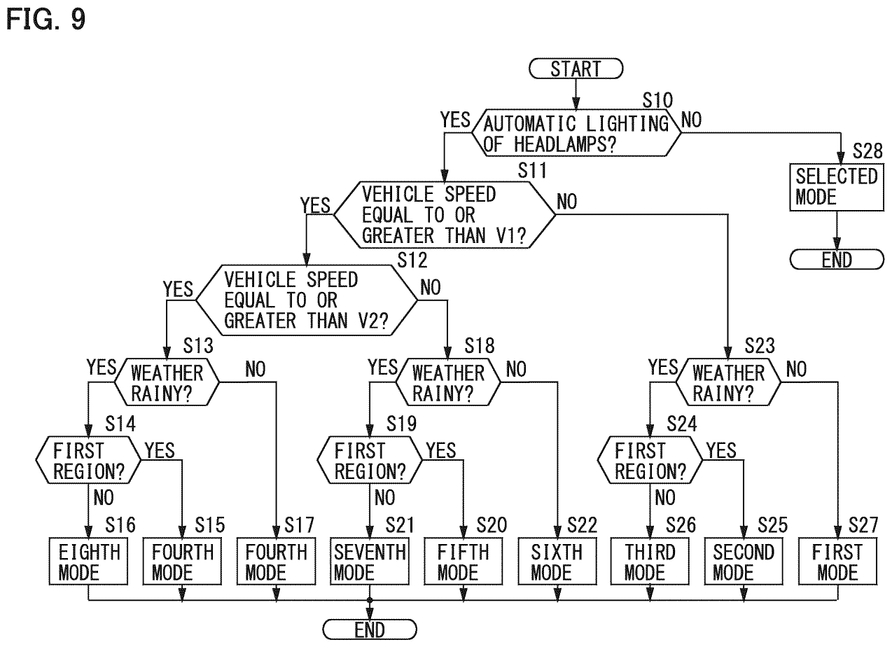

FIG. 9 is a flowchart showing the operating procedure of a vehicle lamp system when it is possible to form an adaptive driving beam (ADB). Here, note that the order of each process shown can be changed as long as no contradictions or inconsistencies occur in the results of the information processing, and other processes not explicitly described here can also be added.

When the operating status of lamp switch 15 operated by the driver indicates automatic lighting of the headlamps (step S10; YES), when the determined vehicle speed of the own vehicle based on the output of vehicle speed sensor 16 is equal to or greater than a predetermined threshold value V1 (step S11; YES), when the vehicle speed is equal to or greater than predetermined threshold value V2 that is greater than V1 (step S12; YES), when the weather condition based on the output of rainfall amount sensor 12 is determined to be rainy (step S13; YES), and further, when the weather condition based on the output of rainfall amount sensor 12 and the output of raindrop sensor 13 is determined to fall within the “first region” (refer to FIG. 2) (step S14; YES), light distribution pattern setting unit 21 of controller 10 sets the illumination pattern of each headlight unit 30L, 30R to the “fourth mode” (step S15). Based on this set irradiation pattern, a control signal is generated by control signal generating unit 22 and output to each headlight unit 30L, 30R, thereby executing fourth mode light irradiation (refer to FIG. 6(c) and FIG. 6(d)).

The threshold values V1 and V2 can be set appropriately based on experiments or simulations, and for example, V1 can be set to 30 km/h and V2 to 50 km/h. The condition branch using threshold value V1 in step S11 is for determining whether or not to use an adaptive driving beam. This is because, when the own vehicle is traveling at a speed less than threshold value V1 such as driving in an urban area for example, it is considered that the situation is not suitable for using the adaptive driving beam. Here, in this condition branch, determination may be made using the lighting conditions around the own vehicle (night, urban area, ambient illuminance), light emitted by headlights and blinkers of oncoming vehicles, light emitted by taillights and blinkers of preceding vehicles, etc., for example. Further, the condition branch for determining whether the weather is rainy or not may be based on the amount of rainfall, or the wiper operation status, weather information obtained from outside the vehicle via communication, ambient illuminance, vehicle speed range, number of lanes, number of streetlights, presence or absence of a tunnel, steering angle, yaw rate, etc.

When the weather condition based on the output of rainfall amount sensor 12 and the output of raindrop sensor 13 is determined to fall within the “second region” (refer to FIG. 2) (step S14; NO), light distribution pattern setting unit 21 of controller 10 sets the irradiation pattern of each headlight unit 30L, 30R to the “eighth mode” (step S16). Based on this set irradiation pattern, control signal generating unit 22 generates a control signal and outputs the signal to each headlight unit 30L, 30R, thereby executing eighth mode light irradiation (refer to FIG. 6(A) and FIG. 6(B)).

Further, when the weather condition based on the output of rainfall amount sensor 12 is determined to be not rainy (step S13; NO), light distribution pattern setting unit 21 of controller 10 sets the irradiation pattern of each headlight unit 30L, 30R to the “fourth mode” (step S17). Based on this set irradiation pattern, control signal generating unit 22 generates a control signal and outputs the signal to each headlight unit 30L, 30R, thereby executing fourth mode light irradiation (refer to FIG. 6(C) and FIG. 6(D)).

On the other hand, when the vehicle speed of the own vehicle, which is determined based on the output of vehicle speed sensor 16, is less than the threshold value V2 (step S12; NO), and when the weather condition based on the output of rainfall amount sensor 12 is rainy (step S18; YES), and further, when the weather condition which is determined based on the output of rainfall amount sensor 12 and the output of raindrop sensor 13, is determined to fall within the “first region” (refer to FIG. 2) (step S19; YES), light distribution pattern setting unit 21 of controller 10 sets the irradiation pattern of each headlight unit 30L, 30R to the “fifth mode” (step S20). Based on this set irradiation pattern, a control signal is generated by control signal generating unit 22, and is output to each headlight unit 30L, 30R, thereby executing fifth mode light irradiation (refer to FIG. 7(A) and FIG. 7(B)).

Further, when the weather condition based on the output of rainfall amount sensor 12 and the output of raindrop sensor 13 is determined to fall within the “second region” (refer to FIG. 2) (step S19; NO), light distribution pattern setting unit 21 of controller 10 sets the irradiation pattern of each headlight unit 30L, 30R to the “seventh mode” (step S21). Based on this set irradiation pattern, control signal generating unit 22 generates a control signal and outputs the signal to each headlight unit 30L, 30R, thereby executing seventh mode light irradiation (refer to FIG. 8(A) and FIG. 8(B)).

Further, when the weather condition based on the output of rainfall amount sensor 12 is determined to be not rainy (step S18; NO), light distribution pattern setting unit 21 of controller 10 sets the irradiation pattern of each headlight unit 30L, 30R to the “sixth mode” (step S22). Based on this set irradiation pattern, control signal generating unit 22 generates a control signal and outputs the signal to each headlight unit 30L, 30R, thereby executing sixth mode light irradiation (refer to FIG. 7(C) and FIG. 7(D)).

On the other hand, when the vehicle speed of the own vehicle based on the output of vehicle speed sensor 16 is determined to be less than the threshold value V1 (step S11; NO), and when the weather condition based on the output of rainfall amount sensor 12 is determined to be rainy (step S23; YES), and further, when the weather condition based on the output of rainfall amount sensor 12 and the output of raindrop sensor 13 is determined to fall within the “first region” (refer to FIG. 2) (step S24; YES), light distribution pattern setting unit 21 of controller 10 sets the irradiation pattern of each headlight unit 30L, 30R to the “second mode” (step S25). Based on this set irradiation pattern, control signal generating unit 22 generates a control signal and outputs the signal to each headlight unit 30L, 30R, thereby executing second mode light irradiation (refer to FIG. 5(C) and FIG. 5(D)).

Further, when the weather condition based on the output of rainfall amount sensor 12 and the output of raindrop sensor 13 is determined to fall within the “second region” (refer to FIG. 2) (step S24; NO), light distribution pattern setting unit 21 of controller 10 sets the irradiation pattern of each headlight unit 30L, 30R to the “third mode” (step S26). Based on this set irradiation pattern, control signal generating unit 22 generates a control signal and outputs the signal to each headlight unit 30L, 30R, thereby executing third mode light irradiation (refer to FIG. 6(A) and FIG. 6(B)).

Further, when the weather condition based on the output of rainfall amount sensor 12 is determined to be not rainy (step S23; NO), light distribution pattern setting unit 21 of controller 10 sets the irradiation pattern of each headlight unit 30L, 30R to the “first mode” (step S27). Based on this set irradiation pattern, control signal generating unit 22 generates a control signal and outputs the signal to each headlight unit 30L, 30R, thereby executing first mode light irradiation (refer to FIG. 5(A) and FIG. 5(B)).

On the other hand, when the operating status of lamp switch 15 operated by the driver does not indicate automatic lighting of the headlamps but indicates a manual selection (step S10; NO), light distribution pattern setting unit 21 of controller 10 sets the irradiation pattern to one of the first, second, third, seventh, or eighth modes according to the operating status of lamp switch 15 (step S28). Based on this selected irradiation pattern, control signal generating unit 22 generates a control signal and outputs the signal to each headlight unit 30L, 30R, thereby executing light irradiation of one of the above modes.

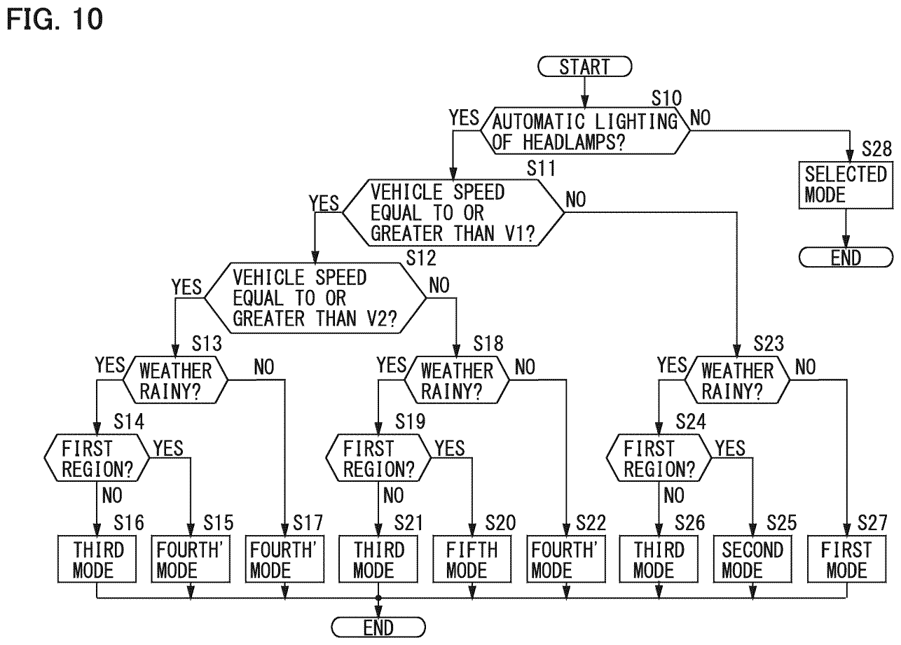

FIG. 10 is a flowchart showing the operating procedure of a vehicle lamp system when it is not possible to form an adaptive driving beam (ADB). Here, note that the order of each process shown here can be changed as long as no contradictions or inconsistencies occur in the results of the information processing, and other processes not explicitly described here can also be added.

The operating procedure shown in FIG. 10 is basically the same as the operating procedure shown in FIG. 9, with the exception that the irradiation patterns set in steps S15, S16, S17, S21, and S22 are different. Therefore, only the differences will be described. In each of steps S15, S17, and S22, instead of the case in FIG. 9, the fourth′ mode is set. The fourth′ mode is a mode in which a normal high beam is used instead of an adaptive driving beam. Further, in each of steps S16 and S21, instead of the case in FIG. 9, the third mode is set.

According to the above embodiment, it is possible to more accurately avoid the occurrence of light veiling phenomenon and to further improve the visibility of pedestrians on the roadside. Further, it is possible to improve forward visibility.

Here, note that the present disclosure is not limited to the contents of the above-described embodiment, and various modifications can be made within the scope of the gist of the disclosure. For example, the above-described embodiment illustrates a case in which a vehicle drives on the left side of the road, however, alternatively, in a case where the vehicle drives on the right side of the road, needless to say that it is sufficient to reverse the left and right in the above-described embodiment in order to carry out the control.

Further, in the above-described embodiment, when the vehicle speed is less than threshold value V1 and the weather is clear, the first mode is set to illuminate only a low beam (refer to FIG. 3 and FIG. 4). However, the second or third mode may be set to illuminate the pedestrian-emphasizing low beam in addition. Thus, this improves the ease of spotting pedestrians in clear weather.

The present disclosure has features as appended below.

### Appendix 1

A control apparatus for a vehicle lamp for controlling the operation of the vehicle lamp having a variable light distribution pattern comprising:
a first sensor capable of detecting an amount of rainfall;
a second sensor capable of detecting size of raindrops; and
a controller connected to each of the first sensor and the second sensor;
where the controller controls the vehicle lamp to emit a first beam when a relationship between the amount of rainfall detected by the first sensor and the size of raindrops detected by the second sensor corresponds to a first weather condition that is estimated not to cause occurrence of a light veiling phenomenon; and
where the controller controls the vehicle lamp to emit a second beam having an illuminance set relatively lower than that of the first beam when the relationship between the amount of rainfall detected by the first sensor and the size of raindrops detected by the second sensor corresponds to a second weather condition that is estimated to cause occurrence of the light veiling phenomenon.

### Appendix 2

The control apparatus for a vehicle lamp according to appendix 1,
where the second beam has a relatively small component that illuminates the front of an own vehicle compared to the first beam.

### Appendix 3

The control apparatus for a vehicle lamp according to appendix 1 or 2,
where the vehicle lamp includes a pair of headlight units installed on the right and left sides of the front of an own vehicle,
where the first beam is configured by combining beams emitted from each of the pair of headlight units toward an area including a side of an own vehicle's lane, and
where, among the pair of the headlight units, the second beam is configured using a beam emitted from the headlight unit that is relatively closer to the road shoulder on the lane on which the own vehicle is traveling toward an area including the side of the own vehicle's lane.

### Appendix 4

The Control Apparatus for a Vehicle Lamp According to Any One of Appendices 1 to 3,
where the first weather condition and the second weather condition correspond to two regions separated by a boundary obtained by setting the amount of rainfall and the size of the raindrops as variables, and
where the controller determines that the first weather condition applies when the relationship between the amount of rainfall and the size of the raindrops falls in the first region of the two regions, and controls the vehicle lamp as if the second weather condition applies when the relationship between the amount of rainfall and the size of the raindrops falls in the second region of the two regions.

### Appendix 5

The control apparatus for a vehicle lamp according to any one of appendices 1 to 4,
where the controller controls the vehicle lamp to emit a low beam together with the first beam or the second beam.

### Appendix 6

The control apparatus for a vehicle lamp according to appendix 5,
where the first beam and the second beam are each irradiated in an overlapping manner within the irradiation range of the low beam.

### Appendix 7

The control apparatus for a vehicle lamp according to appendix 5,
where, when the vehicle speed of an own vehicle is equal to or greater than a first threshold value and the first weather condition is met, the controller controls the vehicle lamp to emit an adaptive driving beam, which dims or shields a range within a high beam illumination range according to the position of another vehicle in front of an own vehicle, together with the first beam and the low beam,
where, when the vehicle speed of the vehicle is equal to or greater than the first threshold value and the second weather condition is met, the controller controls the vehicle lamp to emit a third beam toward an area including a side of the own vehicle's lane, together with the second beam and the low beam, and
where the third beam is a beam that is emitted relatively higher than the second beam in the vertical direction.

### Appendix 8

The control apparatus for a vehicle lamp according to appendix 7,
where, when the vehicle speed of the own vehicle is equal to or greater than a second threshold which is greater than the first threshold, and the first weather condition is met, the controller controls the vehicle lamp so that the first beam is not emitted and the low beam and the adaptive driving beam are emitted, and
where, when the vehicle speed of the vehicle is equal to or greater than the second threshold which is greater than the first threshold, and the second weather condition is met, the controller controls the vehicle lamp so that the second beam is not emitted and the low beam and the third beam are emitted.

### Appendix 9

The control apparatus for a vehicle lamp according to appendix 5,
where, when the vehicle speed of an own vehicle is equal to or greater than a first threshold value, and the first weather condition is met, the controller controls the vehicle lamp to emit a high beam together with the first beam and the low beam, and
where, when the vehicle speed of the own vehicle is equal to or greater than the first threshold value, and the second weather condition is met, the controller controls the vehicle lamp to emit the second beam and the low beam.

### Appendix 10

The control apparatus for a vehicle lamp according to appendix 9,
where, when the vehicle speed of the own vehicle is equal to or greater than a second threshold which is greater than the first threshold, and the first weather condition is met, the controller controls the vehicle lamp so that the first beam is not emitted and the low beam and the high beam are emitted, and
where, when the vehicle speed of the own vehicle is equal to or greater than a second threshold which is greater than the first threshold, and the second weather condition is met, the controller controls the vehicle lamp so that the second beam and the low beam are emitted.

### Appendix 11

A vehicle lamp system including:
the control apparatus according to any one of appendices 1 to 10; and
a vehicle lamp connected to the control apparatus.

### REFERENCE SIGNS LIST

10: Controller
11: Camera
12: Rainfall amount sensor
13: Raindrop sensor
14: Wiper switch
15: Lamp switch
16: Vehicle speed sensor
30L, 30R: Headlight units
h: Pedestrian
LB: Low beam
SB: Pedestrian-emphasizing low beam
SB′: Pedestrian-emphasizing low beam (one side)
ADB: Adaptive driving beam
HB: High beam
SHB: Pedestrian-emphasizing high beam

1. A control apparatus for a vehicle lamp for controlling the operation of the vehicle lamp having a variable light distribution pattern comprising:
a first sensor capable of detecting an amount of rainfall;
a second sensor capable of detecting size of raindrops; and
a controller connected to each of the first sensor and the second sensor;
wherein the controller controls the vehicle lamp to emit a first beam when a relationship between the amount of rainfall detected by the first sensor and the size of raindrops detected by the second sensor corresponds to a first weather condition that is estimated not to cause occurrence of a light veiling phenomenon; and
wherein the controller controls the vehicle lamp to emit a second beam having an illuminance set relatively lower than that of the first beam when the relationship between the amount of rainfall detected by the first sensor and the size of raindrops detected by the second sensor corresponds to a second weather condition that is estimated to cause occurrence of the light veiling phenomenon.

2. The control apparatus for a vehicle lamp according to claim 1,
wherein the second beam has a relatively small component that illuminates the front of an own vehicle compared to the first beam.

3. The control apparatus for a vehicle lamp according to claim 1,
wherein the vehicle lamp includes a pair of headlight units installed on the right and left sides of the front of an own vehicle,
wherein the first beam is configured by combining beams emitted from each of the pair of headlight units toward an area including a side of an own vehicle's lane, and
wherein, among the pair of the headlight units, the second beam is configured using a beam emitted from the headlight unit that is relatively closer to the road shoulder on the lane on which the own vehicle is traveling toward an area including the side of the own vehicle's lane.

4. The control apparatus for a vehicle lamp according to claim 1,
wherein the first weather condition and the second weather condition correspond to two regions separated by a boundary obtained by setting the amount of rainfall and the size of the raindrops as variables, and
wherein the controller determines that the first weather condition applies when the relationship between the amount of rainfall and the size of the raindrops falls in the first region of the two regions, and controls the vehicle lamp as if the second weather condition applies when the relationship between the amount of rainfall and the size of the raindrops falls in the second region of the two regions.

5. The control apparatus for a vehicle lamp according to claim 1,
wherein the controller controls the vehicle lamp to emit a low beam together with the first beam or the second beam.

6. The control apparatus for a vehicle lamp according to claim 5,
wherein the first beam and the second beam are each irradiated in an overlapping manner within the irradiation range of the low beam.

7. The control apparatus for a vehicle lamp according to claim 5,
wherein, when the vehicle speed of an own vehicle is equal to or greater than a first threshold value, and the first weather condition is met, the controller controls the vehicle lamp to emit an adaptive driving beam, which dims or shields a range within a high beam illumination range according to the position of another vehicle in front of an own vehicle, together with the first beam and the low beam,
wherein, when the vehicle speed of the vehicle is equal to or greater than the first threshold value, and the second weather condition is met, the controller controls the vehicle lamp to emit a third beam toward an area including a side of the own vehicle's lane, together with the second beam and the low beam, and
wherein the third beam is a beam that is emitted relatively higher than the second beam in the vertical direction.

8. The control apparatus for a vehicle lamp according to claim 7,
wherein, when the vehicle speed of the own vehicle is equal to or greater than a second threshold which is greater than the first threshold, and the first weather condition is met, the controller controls the vehicle lamp so that the first beam is not emitted and the low beam and the adaptive driving beam are emitted, and
wherein, when the vehicle speed of the own vehicle is equal to or greater than the second threshold which is greater than the first threshold, and the second weather condition is met, the controller controls the vehicle lamp so that the second beam is not emitted and the low beam and the third beam are emitted.

9. The control apparatus for a vehicle lamp according to claim 5,
wherein, when the vehicle speed of an own vehicle is equal to or greater than a first threshold value, and the first weather condition is met, the controller controls the vehicle lamp to emit a high beam together with the first beam and the low beam, and
wherein, when the vehicle speed of the own vehicle is equal to or greater than the first threshold value, and the second weather condition is met, the controller controls the vehicle lamp to emit the second beam and the low beam.

10. The control apparatus for a vehicle lamp according to claim 9,
wherein, when the vehicle speed of the own vehicle is equal to or greater than a second threshold which is greater than the first threshold, and the first weather condition is met, the controller controls the vehicle lamp so that the first beam is not emitted and the low beam and the high beam are emitted, and
wherein, when the vehicle speed of the own vehicle is equal to or greater than a second threshold which is greater than the first threshold, and the second weather condition is met, the controller controls the vehicle lamp so that the second beam and the low beam are emitted.

11. A vehicle lamp system comprising:
a control apparatus according to claim 1; and
a vehicle lamp connected to the control apparatus.
